(19) United States
(12) Patent Application Publication
(10) Pub. No.: US 2007/0051176 A1
(43) Pub. Date: Mar. 8, 2007

(54) Passive hybrid lc/SAW/BAW wireless sensor

(75) Inventor: James ZT Liu, Belvidere, IL (US)

Correspondence Address: Kris T. Fredrick Attorney, Intellectual Property;Honeywell International Inc., 101 Columbia Rd., P.O. Box 2245, Morristown, NJ, 07962, US

(73) Assignee: Honeywell International Inc.

(21) Appl. No.: 11/223,375

(22) Filed: Sep. 8, 2005

(51) Int. Cl. G01N 29/00

(52) U.S. Cl. 73/579

(57) ABSTRACT

An acoustic wave device can be used in a passive sensor when an interrogation signal is inductively coupled into the sensor. The advantage of inductive coupling is that the interrogation signal can power the sensor. The acoustic wave device can be sensitive to environmental factors, such as pressure, temperature, or chemicals. An environmental factor can cause a change in the acoustic wave device resulting in changing the sensor's fundamental frequency. An interrogation circuit containing a grid dip oscillator can produce the interrogation signal, detect the sensor's fundamental frequency, and thereby produce a measurement of the environmental factor.

### TECHNICAL FIELD

Embodiments relate to the field of sensing circuits. Embodiments also relate to surface acoustic wave devices and bulk acoustic wave sensors. Embodiments additionally relate to using an acoustic wave device to vary the frequency of an inductively coupled load.

### BACKGROUND

Acoustic wave devices often have one or two transducers arranged on a piezoelectric substrate. A transducer can convert an electrical input signal into an acoustic signal. The acoustic wave device can then alter the acoustic signal as it propagates through, or along, the substrate. A transducer can also convert the acoustic signal into an electrical signal. One common use of acoustic wave devices is conditioning or filtering signals, such as filtering the electrical signal received by a cellular telephone, because acoustic wave devices can be extremely good and inexpensive signal filters.

Acoustic wave devices are also used as sensors. A sensor's piezoelectric substrate can be sensitive to environmental conditions. It can expand or contract with the temperature. Pressure can cause it to flex. Some chemical sensors are based on acoustic wave devices such that exposure to a chemical, such as water or alcohol, can introduce mass-loading effect to the sensor. Stressing or flexing the substrate of an acoustic wave device can change its acoustic properties. The changing acoustic properties can affect the acoustic signals which become electrical signals at the transducers. As such, acoustic wave devices have been used to measure temperature, pressure, chemical densities, and other environmental properties.

One type of acoustic wave device is a surface acoustic wave device (SAW) in which the acoustic waves propagate along the surface of a substrate. A common variety of SAW has an input transducer, an output transducer, and a substrate. An electrical signal enters the input transducer, becomes an acoustic signal, and travels over the substrate surface to the output transducer. The output transducer then converts the acoustic signal into an output electrical signal.

Another type of acoustic wave device is a bulk acoustic wave device (BAW) in which the acoustic waves travel through a substrate. BAW devices can be used in applications similar to those of SAWs and other acoustic wave devices. When used as sensors, BAWs have higher effective sensitivity, higher resolution, ease of use in liquid applications, and larger dynamic range than SAWs. However, SAWs typically have a larger bandwidth. Furthermore, SAWs can often receive an electromagnetic signal, such as a radio wave, directly into the input transducer. Generally, it can be far easier to put signals into and get signals out of a SAW.

A sensor can not be advantageously employed unless an interrogation circuit is also employed. An interrogation circuit is a circuit that creates an interrogation signal that is passed to the sensor. The sensor then returns a response signal or affects the interrogation signal in some way. For example, an electronic thermometer can accept an interrogation signal comprising power and ground while returning a voltage proportional to the temperature as a response signal. Alternatively, a material that changes its electrical resistance can be used as a temperature sensor. The interrogation signal can be power and ground voltages while the current passing through the material is the response signal.

An interrogation signal can be passed to a sensor in a number of ways. One way is to use an electrical connection where wires carry the interrogation signal from the interrogation circuit, to the sensor, and back to the interrogation circuit. A second way is radio transmission. An interrogation signal is transmitted as a radio signal from the interrogation circuit to the sensor which then transmits a response back. Some sensors continuously transmit a radio signal without being interrogated. A third way is inductive coupling. The interrogation signal is passed through a first inductor that is inductively coupled to a second inductor that is connected to, or part of, a sensor. The advantage of inductive coupling over radio transmission is that the interrogation circuit can supply power to the sensor. As such, the sensor can be passive, having no power until an interrogation circuit supplies power.

FIG. 1, labeled as prior art, illustrates an interrogation circuit 101 inductively coupled to a sensor 102. The interrogation circuit passes an interrogation signal through a first inductor 103 from which it is inductively coupled into a second inductor 104. The sensor 102 and second inductor 104 appear as an inductive load to the interrogation circuit 101.

FIG. 2, labeled as prior art, illustrates an inductively coupled interrogation circuit 101. A function generator 201 can produce a signal by making a voltage ramp repeat over and over. Those skilled in the arts of electronics or signaling often call this a saw tooth signal. The saw tooth signal is passed to a voltage controlled oscillator 202 (VCO). VCOs produce a signal with a frequency dependent on a voltage input. The saw tooth signal causes the VCO 202 to produce an interrogation signal that repeatedly sweeps through a range of frequencies. The interrogation signal is passed to an inductor 103, a grid dip oscillator (GDO) 203, and a phase locked loop (PLL) 204. The inductor 103 can inductively couple the interrogation signal into an inductive load (not shown).

The efficiency with which the interrogation signal is coupled into an inductive load depends on the inductive load and the interrogation signal frequency. Many circuits, including inductive loads, have a fundamental frequency. When the interrogation signal frequency matches the fundamental frequency, the coupling is maximized. As the interrogation signal sweeps through a frequency range, the fundamental frequency can be detected by the GDO 203 because the voltage across the inductor 103 drops to a minimum value at the inductive load's fundamental frequency. The GDO 203 signals the PLL 204 at the fundamental frequency. A PLL 204 is an oscillator that can lock onto and follow a source signal. As such, the PLL 204 locks onto and follows the interrogation signal. When signaled by the GDO 203, however, the PLL 204 can stop following the interrogation signal and remain producing a locked signal at the inductive load's fundamental frequency. The locked signal is passed to a frequency counter 205. The frequency counter 205 supplies a reading of the inductive load's fundamental frequency. If the inductive load is a sensor that changes its fundamental frequency based on an environmental factor, such as pressure, then the fundamental frequency is also a measure of that environmental factor.

The system of FIG. 2 illustrates an interrogation circuit that can measure the fundamental frequency of an inductive load. Similar interrogation circuits are disclosed in U.S. Pat. No. 3,092,806 and U.S. Pat. No. 3,906,340. U.S. Pat. No. 3,092,806 and U.S. Pat. No. 3,906,340 are incorporated by reference into this document.

Current technology supplies sensors that change their fundamental frequency based on environmental factors. Those sensors, however, tend to be larger, more complex, less precise, and less accurate than acoustic wave based sensors. Acoustic wave based sensors, however, have not been used as variable inductive loads having a fundamental frequency correlated to their environment.

Aspects of the embodiments directly address the shortcoming of current technology by supplying methods and systems by which acoustic wave sensors can be inductively coupled to an interrogation circuit and whereby the inductive load seen by the interrogation sensor has a fundamental frequency that can change based on environmental conditions such as temperature, pressure, or chemical densities.

### BRIEF SUMMARY

It is therefore an aspect of the embodiments to inductively couple a sensor to an interrogation circuit. The sensor includes an acoustic wave device, such as a surface acoustic wave device or a bulk acoustic wave device. The sensor can also include an inductor that takes part in the inductive coupling. The sensor can also include a trim capacitor that can be used to adjust the sensor's fundamental frequency. The interrogation circuit includes a grid dip oscillator for detecting when the frequency of the interrogation signal matches the sensor's fundamental frequency.

It is another aspect of the embodiments that the sensor's fundamental frequency changes in reaction to the sensor's environment. For example, changes in the temperature or pressure to which the sensor is exposed can change the sensor's fundamental frequency. Chemicals, such as alcohol or water, in the sensor's environment can also cause changes in the sensor's fundamental frequency. As such, a measurement of the sensor's fundamental frequency is also a measurement of the sensor's environment. For example, the measured fundamental frequency can indicate the sensor's temperature. The interrogation circuit can measure the sensor's fundamental frequency and thereby also measure the sensor's environment.

It is also another aspect of the embodiments to generate an interrogation signal that scans through a frequency range containing the sensor's fundamental frequency and to inductively couple the interrogation signal into the sensor. Observing the inductive coupling efficiency, as is possible with a grid dip oscillator, can reveal the sensor's fundamental frequency, thereby producing a measurement of the sensor's environment. The sensor includes an acoustic wave device, such as a surface acoustic wave device or a bulk acoustic wave device.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1, labeled as prior art, illustrates an interrogation circuit inductively coupled to a sensor in accordance with an aspect of an embodiment;

FIG. 2, labeled as prior art, illustrates an inductively coupled interrogation circuit in accordance with an aspect of an embodiment;

FIG. 3 illustrates a SAW sensor electrically connected to a trim capacitor in accordance with an aspect of an embodiment;

FIG. 4 illustrates a BAW sensor electrically connected to a trim capacitor in accordance with an aspect of an embodiment; and

FIG. 5 illustrates a high level flow diagram of reading a sensor measurement from an inductively coupled interrogation signal in accordance with aspects of the embodiments.

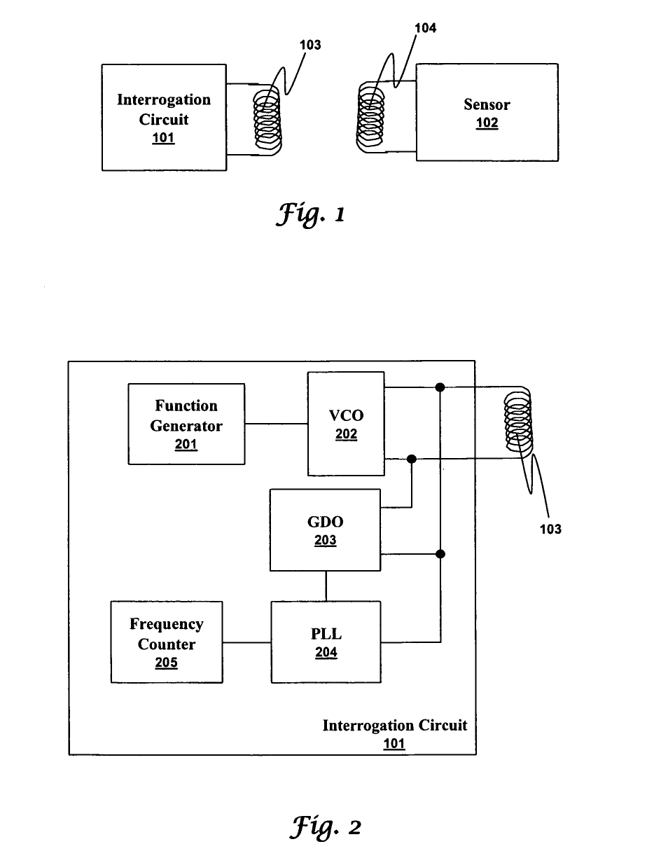

### DETAILED DESCRIPTION

The particular values and configurations discussed in these non-limiting examples can be varied and are cited merely to illustrate at least one embodiment and are not intended to limit the scope thereof.

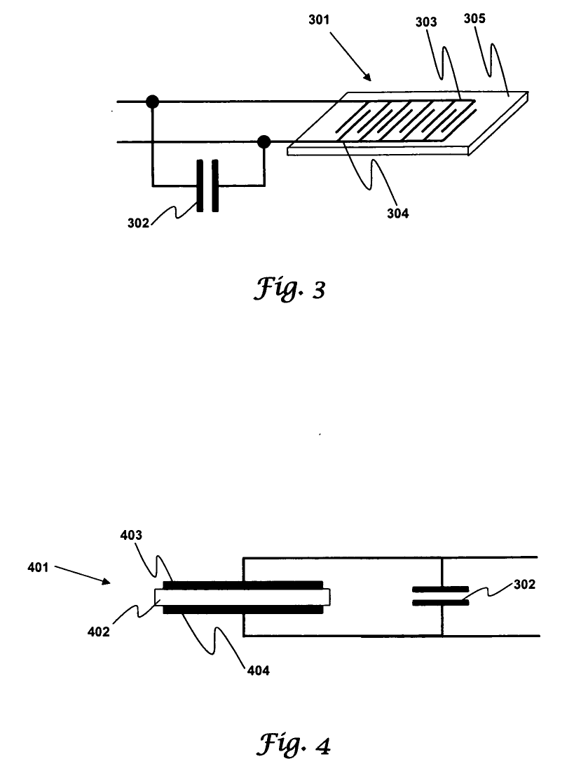

FIG. 3 illustrates a surface acoustic wave (SAW) device 301 electrically connected to a trim capacitor 302 in accordance with an aspect of an embodiment. The SAW device 301 has a first transducer 303 and a second transducer 304 attached to a substrate 305. The SAW device 301 is shown electrically connected in parallel to a trim capacitor 302. The SAW device 301 and trim capacitor 302 can also be electrically connected in parallel to an inductor (not shown). The trim capacitor 302 can be used to adjust the fundamental frequency of the entire sensor unit which includes the trim capacitor 302, the SAW device 301, and possibly other devices.

FIG. 4 illustrates a bulk acoustic wave BAW device 401 electrically connected to a trim capacitor 302 in accordance with an aspect of an embodiment. The BAW device 401 has a first transducer 403 and a second transducer 404 attached to a substrate 402. The BAW device 401 is shown electrically connected in parallel to a trim capacitor 302. The BAW device 301 and trim capacitor 302 can also be electrically connected in parallel to an inductor (not shown). The trim capacitor 302 can be used to adjust the fundamental frequency of the entire sensor unit which includes the trim capacitor 302, the BAW device 301, and possibly other devices.

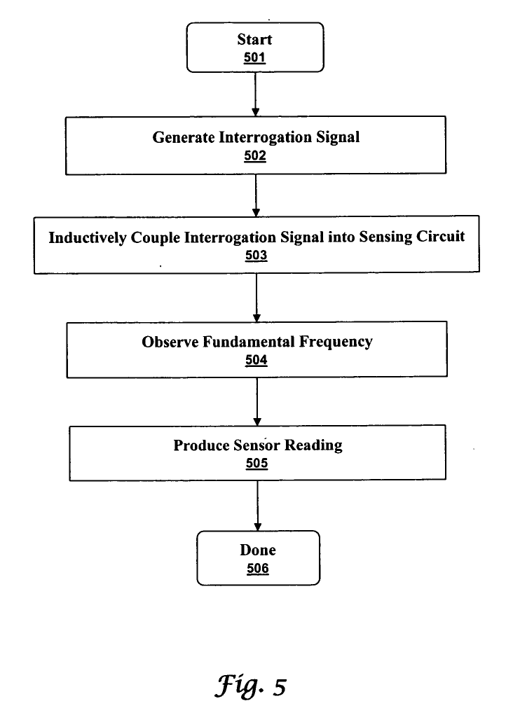

FIG. 5 illustrates a high level flow diagram of reading a sensor measurement from an inductively coupled interrogation signal in accordance with aspects of the embodiments. After the start 501 an interrogation signal is generated 502. Methods and systems for generating interrogation signals are well known to those practiced in the arts of electronics or signaling. A method based on using a function generator creating a saw tooth signal and feeding the saw tooth signal to a voltage controlled oscillator is discussed above. The interrogation signal is then inductively coupled into a sensing circuit 503. The fundamental frequency of the sensing circuit is then observed 504 and used to produce a sensor reading 505 before the process is done 506.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system comprising an interrogation circuit inductively coupled to a sensor comprising a surface acoustic wave device wherein the sensor has a fundamental frequency that changes in response to environmental factors such as temperature, pressure, or chemicals and wherein the interrogation circuit comprises a grid dip oscillator that measures the fundamental frequency.

2. The system of claim 1 with the sensor further comprising an inductor.

3. The system of claim 2 with the sensor further comprising a trim capacitor.

4. The system of claim 1 with the sensor further comprising a trim capacitor.

5. The system of claim 1 wherein the acoustic wave device reacts to changes in pressure and thereby changes the fundamental frequency.

6. The system of claim 1 wherein the acoustic wave device reacts to changes in temperature and thereby changes the fundamental frequency.

7. The system of claim 1 wherein the acoustic wave device reacts to one or more chemicals and thereby changes the fundamental frequency.

8. A system comprising an interrogation inductively coupled to a sensor comprising a bulk acoustic wave device wherein the sensor has a fundamental frequency that changes in response to environmental factors such as temperature, pressure, or chemicals and wherein the interrogation circuit comprises a grid dip oscillator that measures the fundamental frequency.

9. The system of claim 8 with the sensor further comprising an inductor.

10. The system of claim 9 with the sensor further comprising a trim capacitor.

11. The system of claim 8 with the sensor further comprising a trim capacitor.

12. The system of claim 8 wherein the acoustic wave device reacts to changes in pressure and thereby changes the fundamental frequency.

13. The system of claim 8 wherein the acoustic wave device reacts to changes in temperature and thereby changes the fundamental frequency.

14. The system of claim 8 wherein the acoustic wave device reacts to one or more chemicals and thereby changes the fundamental frequency.

15. A method comprising:
generating an interrogation signal that scans through a frequency range;
inductively coupling the interrogation signal into a sensing circuit comprising an acoustic wave device;
observing a fundamental frequency which is the frequency at which the interrogation signal maximally couples into the sensing circuit; and
producing a sensor reading from the fundamental frequency.

16. The method of claim 15 wherein the acoustic wave device is a surface acoustic wave device.

17. The method of claim 15 wherein the acoustic wave is a bulk acoustic wave device.

18. The method of claim 15 further comprising adjusting the fundamental frequency with a trim capacitor.

19. The method of claim 15 further comprising exposing the sensing circuit to a changing temperature such that the fundamental frequency changes and the sensor reading is a temperature measurement.

20. The method of claim 15 further comprising exposing the sensing circuit to a changing pressure such that the fundamental frequency changes and the sensor reading is a pressure measurement.
